(19) United States
(12) Patent Application Publication
(10) Pub. No.: US 2012/0304263 A1
(43) Pub. Date: Nov. 29, 2012

(54) SYSTEM AND METHOD FOR SINGLE SIGN-ON

(75) Inventors: CHUNG-I LEE, Tu-Cheng (TW); HAI-HONG LIN, Shenzhen City (CN); DE-YI XIE, Shenzhen City (CN); SHUAI-JUN TAO, Shenzhen City (CN); ZHI-QIANG YI, Shenzhen City (CN); AN-SHENG LUO, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/450,715

(22) Filed: Apr. 19, 2012

(30) Foreign Application Priority Data
May 24, 2011 (CN) 201110135252.1

(51) Int. Cl. G06F 21/00

(52) U.S. Cl. 726/6

(57) ABSTRACT

A server generates a first ID in response to a user inputting a username on a web portal provided by the server. If the user selects a link page displayed through the web portal, the server generates a second ID and sends the first ID and the second ID to the selected link page. The server detects if the user can access the selected link page by reference to the first ID and the second ID. If the server verifies the information successfully, the link page may be entered using the portal information.

### BACKGROUND

1. Technical Field

Embodiments of the present disclosure relate to access control systems and methods, and more particularly to a system and a method for single sign-on.

2. Description of Related Art

Single sign-on is a property of access control for multiple related, but independent, software systems. With the single sign-on feature a user logs in once to one system and gains access to all systems without being prompted to log in again in each of them. However, if an authorized user enters link pages from a web portal, private information of the user may be obtained by unauthorized people. The unauthorized person may view the linked pages by using the obtained information of the authorized user.

### BRIEF DESCRIPTION OF THE DRAWINGS

FIG. 1 is a block diagram of one embodiment of a server comprising a single sign-on system.

FIG. 2 is a block diagram of one embodiment of the function modules of the single sign-on system in the server of FIG. 1.

FIG. 3 is a flowchart illustrating one embodiment of a method for single sign-on.

FIG. 4 is a detailed flowchart illustrating block S35 of FIG. 3.

FIG. 5 illustrates one embodiment of a user login table in a method for single sign-on.

FIG. 6 illustrates one embodiment of a first system login table.

FIG. 7 illustrates one embodiment of a second system login table.

FIG. 8 illustrates one embodiment of a relationship table in a method for single sign-on.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

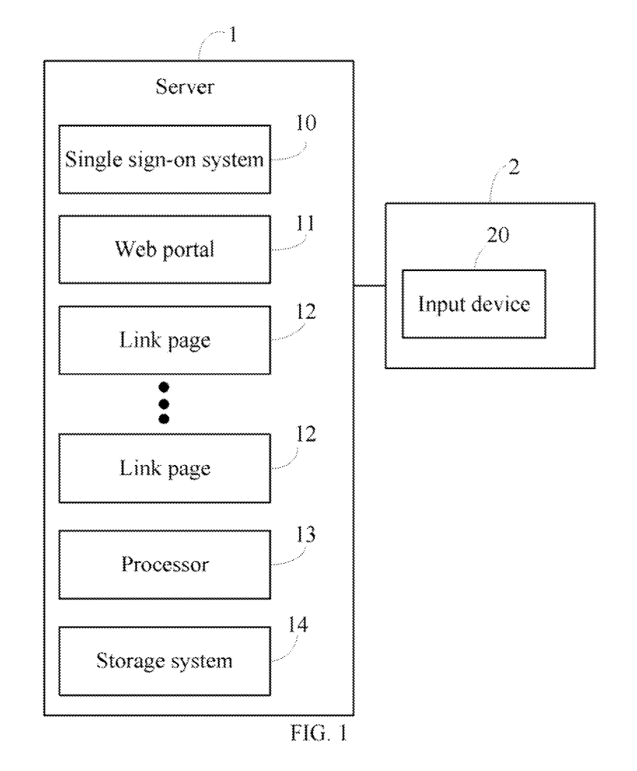

FIG. 1 is a block diagram of one embodiment of a server 1 comprising a single sign-on system 10. The server 1 provides a web portal 11 and more than one link pages 12. The web portal 11 or a link page 12 is a web site that functions as a point of access to information in the World Wide Web. The web portal 11 presents information from diverse sources in a unified way. The server 1 electronically connects to at least one client 2. Each client 2 includes an input device 20. The input device 20 may be a keyboard or a touch screen. Users can input information via the input device 20 to enter the web portal 11 and the link pages 12.

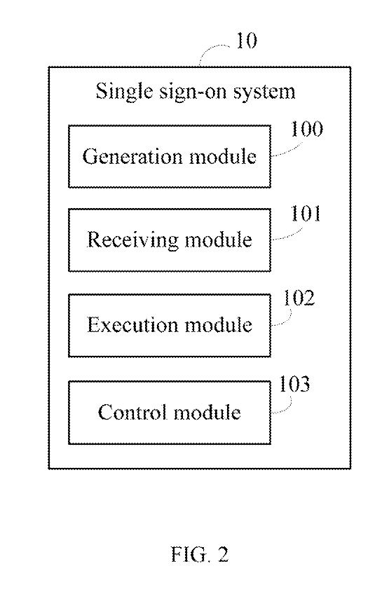

In an exemplary embodiment, the server 1 includes at least one processor 13 and a storage system 14. The single sign-on system 10 may include one or more modules (as in FIG. 2). The one or more modules may comprise computerized code in the form of one or more programs that are stored in the storage system 14. In one embodiment, the storage system 14 may be a magnetic or an optical storage system, such as a flash memory, or other suitable storage medium. The computerized code includes instructions that are executed by the at least one processor 13 to provide functions for the one or more modules described below.

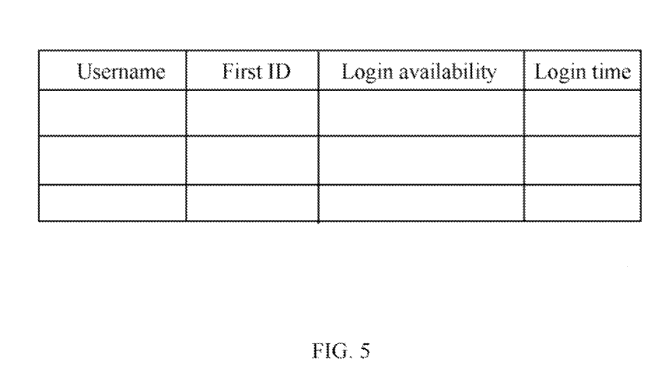

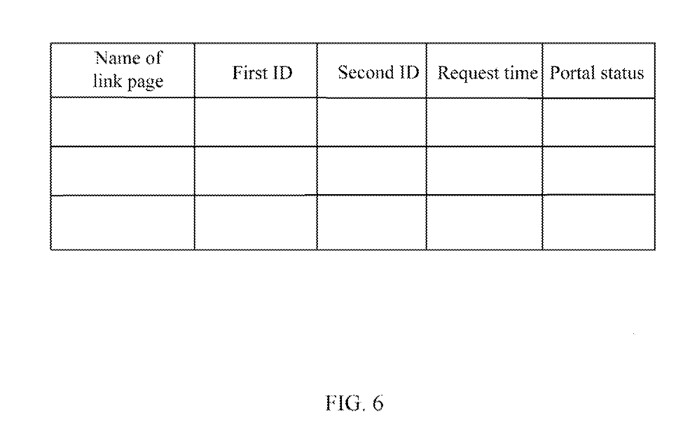

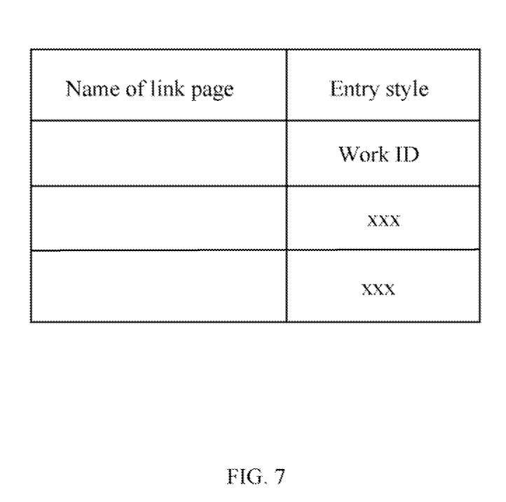

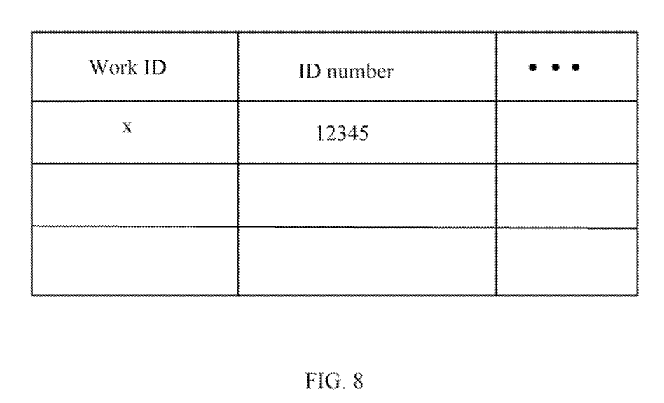

The storage system 14 stores a name of each link page 12, a user login table, a first system login table, a second system login table, and a relationship table. The user login table stores entry information of the web portal 11. The entry information of the web portal 11 includes username(s), login time and login availability, as shown in FIG. 5. The login availability indicates if a username has already been entered into the web portal 11. The first system login table stores information of the link pages 12 which are requested by a user. As shown in FIG. 6, the information of the link pages 12 includes the time of request of accessing the link pages 12, entry status of the link pages 12, and names of the link pages 12. As shown in FIG. 7, the second system login table stores the name of each link page 12 and an entry style of each link page 12. The entry style presents styles of entering each link page 12. The entry style may be either “work identifier (ID)” or “ID number.” The relationship table stores values of the entry style. For example, as shown in FIG. 8, if the entry style is “work ID” and value of the work ID is “x” and another value of the ID number is “12345”, the relationship table stores the “x” and the “12345.”

As shown in FIG. 2, the single sign-on system 10 may include a generation module 100, a receiving module 101, an execution module 102, and a control module 103.

The generation module 100 generates a first ID if the user inputs a username via the input device 20 to enter the web portal 11. The generation module 100 further stores the first ID and the username into the user login table. In one embodiment, the first ID is a 32-bit character string. If the user enters the web portal 11 successfully, the generation module 100 sets the login availability of the username to “valid” in the user login table.

The receiving module 101 receives a link page 12 which is selected by the user and displayed on a page of the web portal 11.

The execution module 102 generates a second ID after the receiving module 102 receives the selected link page 12, and stores the first ID, the second ID, and the name of the selected link page 12 into the first system login table, and stores a first current system time of the server 1 as the request time relating to the selected link page 12 into the first system login table. In one embodiment, the second ID is a 32-bit character string. The execution module 102 sends the first ID and the second ID to the selected link page 12. For example, if the website of the selected link page 12 is “url,” the first ID is “x” and the second ID is “y,” the execution module 102 sends the “x” and the “y” by using a sentence of “url+”?userGuid=x&systemGuid=y”” to the selected link page 12.

The control module 103 determines if the user can access the selected link page 12 by using a “Web service” method with the first ID and the second ID, and enters the selected link page 12 if the user can access the selected link page 12. The Web service is a method of communication between two electronic devices over the web.

In one embodiment, the control module 13 checks a value of the login availability corresponding to the first ID in the user login table. If the value of the login availability shows “invalid,” the control module 103 issues a warning that the user cannot access the selected link page 12. If the value of the login availability is “valid,” the control module 103 obtains the username corresponding to the first ID in the user login table, and detects if a value of the entry status of the selected link page 12 which corresponds to the first ID and the second ID is valid. If the value of the entry status of the selected link page 12 is “invalid,” the control module 103 issues a warning that the user cannot access the selected link page 12. If the value of the entry status of the selected link page 12 is “valid,” the control module 103 calculates a difference between a second current system of the server 1 and the request time of the selected link page 12 in the first system login table. If the difference is more than a preset value, the control module 103 issues a warning that the user cannot access the selected link page 12. In one embodiment, the preset value is 1 minute. If the difference is less than or equal to the preset value, the control module 103 sets the value of the entry status of the selected link page 12 as “invalid.”

The control module 103 further determines the entry style corresponding to the name of the selected link page 12 in the second system login table, determines a value of the determined entry style in the relationship table, and enters the selected link page 12 by using the determined value.

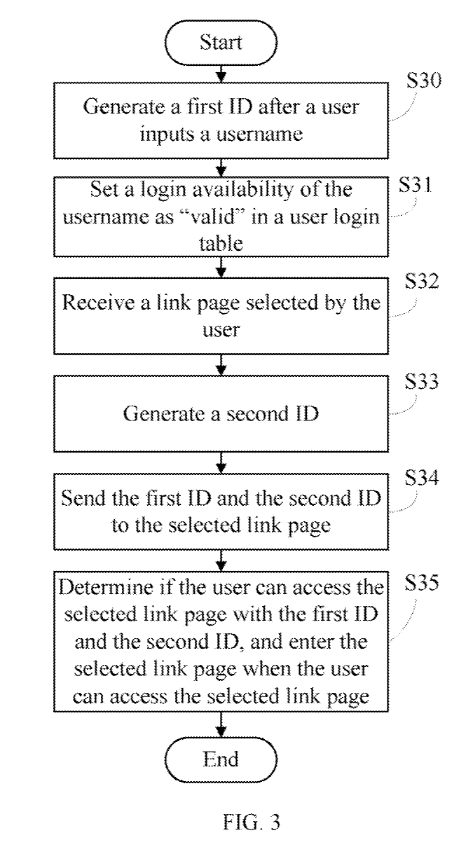

FIG. 3 is a flowchart illustrating a method for single sign-on. Depending on the embodiment, additional steps may be added, others removed, and the ordering of the steps may be changed.

In step S30, the generation module 100 generates a first ID after the user inputs a username via the input device 20, and stores the first ID and the username into the user login table.

In step S31, the generation module 100 sets the login availability of the particular username as “valid” in the user login table.

In step S32, the receiving module 101 receives a link page 12 selected by the user. The web portal 11 displays all the link pages 12.

In step S33, the execution module 102 generates a second ID, stores the first ID, the second ID, and the name of the selected link page 12 into the first login table, and stores a first current time of the server 1 as the request time relating to the selected link page 12 into the first system login table.

In step S34, the execution module 102 sends the first ID and the second ID to the selected link page 12.

In step S35, the control module 103 determines if the user can access the selected link page 12 by using a “Web service” method with the first ID and the second ID, and enters the selected link page 12 if the user can access the selected link page 12.

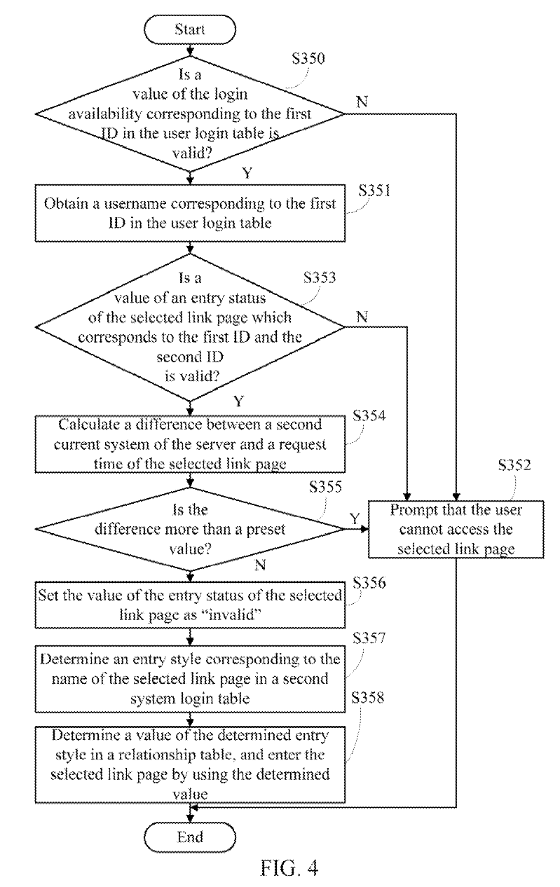

FIG. 4 is a detail flowchart illustrating step S35 of FIG. 3. Depending on the embodiment, additional steps may be added, others removed, and the ordering of the steps may be changed.

In step S350, the control module 103 checks a value of the login availability corresponding to the first ID in the user login table. If the value of the login availability is “valid,” step S351 is implemented. If the value of the login availability shows “invalid,” step S352 is implemented, and the control module 103 issues a warning that the user cannot access the selected link page 12, and the procedure ends.

In step S351, the control module 103 obtains the username corresponding to the first ID in the user login table, and step S353 is implemented.

In step S353, the control module 103 detects if a value of the entry status of the selected link page 12 which corresponds to the first ID and the second ID is valid. If the value of the entry status of the selected link page 12 is “invalid,” step S352 described above is implemented. If the value of the entry status of the selected link page 12 is “valid,” step S354 is implemented.

In step S354, the control module 103 obtains the request time relating to the selected link page 12 in the first system login table, and calculates a difference between a second current system of the server 1 and the request time.

In step S355, the control module 103 detects if the difference is more than a preset value. If the difference is more than the preset value, step S352 described above is implemented. If the difference is not more than the preset value, step S356 is implemented.

In step S356, the control module 103 sets the value of the entry status of the selected link page 12 as “invalid.”

In step S357, the control module 103 determines the entry style corresponding to the name of the selected link page 12 in the second system login table.

In step S358, the control module 103 determines a value of the determined entry style in the relationship table, and enters the selected link page 12 by using the determined value.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server, comprising:
a storage system;
at least one processor; and
one or more programs being stored in the storage system and executable by the at least one processor, the one or more programs comprising:
a generation module operable to generate a first identifier (ID) when a user input a username on a web portal;
an execution module operable to generate a second ID when the user selects a link page provided by the web portal, and send the first ID and the second ID to the selected link page; and
a control module operable to determine when the user can access the selected link page with the first ID and the second ID, and enter the selected link page when the user can access the selected link page.

2. The server as described in claim 1, wherein the generation module further stores the first ID and the username into a user login table, and sets a login availability of the username as “valid” in the user login table.

3. The server as described in claim 1, wherein the execution module is further operable to store the first ID, the second ID, and a name of the selected link page into a first system login table, and store a first current system time of the server as a request time into the first system login table.

4. The server as described in claim 3, wherein the control module is further operable to:
calculate a difference between a second system time of the server and the request time when the value of the entry status of the selected link page is “valid”; and
set the value of the entry status of the selected link page as “invalid,” determine the entry style corresponding to the name of the selected link page, determine a value of the determined entry style in a relationship table, and enters the selected link page by using the determined value of the determined entry style when the difference is not more than a preset value.

5. A computer-based method for single sign-on, the method comprising the steps of:
generating a first identifier (ID) when a user input a username on a web portal;
generating a second ID when the user selects a link page provided by the web portal, and sends the first ID and the second ID to the selected link page; and
determining if the user can access the selected link page inputted by the user with the first ID and the second ID, and entering the selected link page when the user can access the selected link page.

6. The method as described in claim 5, after the step of generating a first identifier (ID) when the user input a username on a web portal further comprising:
storing the first ID and the username into a user login table, and sets a login availability of the username as “valid” in the user login table.

7. The method as described in claim 5, wherein the method further comprises:
storing the first ID, the second ID, and a name of the selected link page into a first system login table, and storing a first current system time of the server as a request time into the first system login table.

8. The method as described in claim 7, wherein the method further comprises:
calculating a difference between a second system time of the server and the request time when the value of the entry status of the selected link page is “valid;” and
setting the value of the entry status of the selected link page as “invalid,” determining the entry style corresponding to the name of the selected link page, determining a value of the determined entry style in a relationship table, and entering the selected link page by using the determined value of the determined entry style when the difference is not more than a preset value.

9. A non-transitory storage medium having stored thereon instructions that, when executed by a processor, cause the processor to perform a method for single sign-on, the method comprising:
generating a first identifier (ID) when a user input a username on a web portal;
generating a second ID when the user selects a link page provided by the web portal, and sends the first ID and the second ID to the selected link page; and
determining if the user can access the selected link page inputted by the user with the first ID and the second ID, and entering the selected link page when the user can access the selected link page.

10. The non-transitory storage medium as described in claim 9, after the step of generating a first identifier (ID) when the user input a username on a web portal further comprising:
storing the first ID and the username into a user login table, and sets a login availability of the username as “valid” in the user login table.

11. The non-transitory storage medium as described in claim 9, wherein the method further comprises:
storing the first ID, the second ID, and a name of the selected link page into a first system login table, and storing a first current system time of the server as a request time into the first system login table.

12. The method as described in claim 11, wherein the method further comprises:
calculating a difference between a second system time of the server and the request time when the value of the entry status of the selected link page is “valid;” and
setting the value of the entry status of the selected link page as “invalid,” determining the entry style corresponding to the name of the selected link page, determining a value of the determined entry style in a relationship table, and entering the selected link page by using the determined value of the determined entry style when the difference is not more than a preset value.
